(19) United States
(12) Patent Application Publication
(10) Pub. No.: US 2020/0056993 A1
(43) Pub. Date: Feb. 20, 2020

(54) MEASURING DEVICE HAVING AN OPTICAL MEASURING ARRANGEMENT AND METHOD FOR CARRYING OUT AN OPTICAL DISTANCE MEASUREMENT USING SUCH A MEASURING ARRANGEMENT

(71) Applicant: Klingelnberg GmbH, Huckeswagen (DE)

(72) Inventors: Georg Mies, Wipperfürth (DE); Fabian Reuter, Köln (DE)

(21) Appl. No.: 16/532,712

(22) Filed: Aug. 6, 2019

(30) Foreign Application Priority Data
Aug. 14, 2018 (DE) 102018119697.0

(51) Int. Cl. G01N 21/63; G01N 21/25

(52) U.S. Cl. CPC G01N 21/63; G01N 2021/015; G01N 21/256

(57) ABSTRACT

A measurement device having
an axis of rotation,
at least one controlled axis,
a receptacle for a component to be measured rotationally-drivable around the axis of rotation, and having
an optical, contactlessly operating measuring arrangement having a light source, an optics arrangement, and an optical detector,
wherein the measuring arrangement is configured for
emitting a light beam from the light source along an optical axis in the direction of an object plane of the component,
guiding light components having different wavelengths, which were reflected on the object plane, through the optics arrangement in the direction of the optical detector,
and wherein the optics arrangement comprises a first partial device and a second partial device, wherein the first partial device is fixedly connected via an optical waveguide to the detector, and wherein the second partial device is removably arranged on the first partial device.

### CROSS-REFERENCE TO RELATED APPLICATIONS

This application claims the benefit under 35 U.S.C. § 119(e) to German patent application no. DE 10 2018 119 697 filed Aug. 14, 2018, which is hereby expressly incorporated by reference as part of the present disclosure.

### FIELD OF THE INVENTION

The present disclosure generally relates to a measuring device having an optical measuring arrangement and a method for carrying out an optical distance measurement using such a measuring arrangement.

### BACKGROUND

In many technical fields, the exact measurement of a component is of great significance.

There are, for example, measuring devices for the tactile acquisition of the condition and the profile of surfaces or the geometry of components. A probe tip is typically guided over the surface to be measured for this purpose. Mechanical measurement is typically time-consuming.

At first glance, optical measurement could represent an alternative to mechanical measurement. The use of optically measuring sensors would be ideal here. An optical measurement approach could represent a feasible alternative above all for the measurement of rotationally-symmetrical components, for example, the gear tooth measurement of gearwheel components.

However, it has been shown that the optically measuring sensors only have limited suitability for the requirements for gear tooth measurement for various reasons. The special requirements or criteria which apply in the case of gear tooth measurement are:

unfavorable scanning angle,

glossy surfaces, for example, of the tooth flanks,

shading due to adjacent teeth,

high requirements for the measurement accuracy (in the range of 0.1-0.5 μm),

soiling problems (for example, due to oil),

risk of destruction of the sensor in the event of a collision with a tooth of the component to be measured, and

interfering refraction or reflection effects, for example, due to multiple reflections in narrow tooth gaps.

There is a demand for being able to perform gear tooth measurements, for example, in the scope of the production or quality control of gearwheel components, to be able to check various gearwheel components.

### SUMMARY

It is therefore an objective to provide a device which enables rapid and precise measurements to be performed on rotationally-symmetrical components, for example, on gearwheel components. Moreover, a corresponding method is to be provided.

Such a measuring task relates in the case of gearwheel components, for example, to the indexing measurement, in which the angle distance from tooth flank to tooth flank is determined.

An exemplary (coordinate) measuring device comprises

an axis of rotation,

at least one controlled axis,

a receptacle (for example, a turntable having clamping device) for a rotationally-symmetrical component to be measured, for example, a gearwheel component, which is rotationally drivable around the axis of rotation, and

an optical, contactlessly operating measuring arrangement having a light source, an optics arrangement, and an optical detector,

this measuring arrangement is designed so that it is capable of

emitting a light beam, originating from the light source along an optical axis in the direction of an object plane of the (e.g., gearwheel) component when this (e.g., gearwheel) component is arranged in the receptacle and

guiding light components having different wavelengths, which were reflected on the object plane, through the optics arrangement in the direction of the optical detector, wherein the optics arrangement comprises a first partial device and a second partial device, wherein the first partial device is fixedly connected via an optical waveguide to the detector, and wherein the second partial device is removably arranged on the first partial device.

At least some embodiments use a confocal-chromatic optical measuring arrangement, which has a high resolution. However, such a measuring arrangement requires a relatively large numeric aperture if one wishes to meet the above-mentioned conditions. A relatively broad light cone thus results. If one wishes to avoid shadows of the light cone on adjacent teeth, unfavorably steep scanning angles result during the gear tooth measurement. In the case of a steep scanning angle, the detector of the measuring arrangement does not receive a usable reflected light signal, however. Alternatively, the optical unit of the confocal-chromatic optical measuring arrangement can be moved relatively close to the surface to be measured, to obtain usable reflected light signals. In addition, however, a suitable distance between the optics arrangement and the object plane of the (e.g., gearwheel) component additionally has to be set as precisely as possible here.

Since the constellation (configuration) suitable in the case of a confocal-chromatic measurement is different with a first (e.g., gearwheel) component than with a second different (e.g., gearwheel) component, various constellations (configurations) of the optics arrangement are also specified in each case when measuring various (e.g., gearwheel) components. To make the refitting of the measuring device efficient, a replaceable optical unit may be used.

The optics arrangement may be configured so that an adaptation can be performed solely by replacing the replaceable optical unit (also called second partial device). This replacement of the replaceable optical unit can take place efficiently, since a positioning arrangement is used which enables the second partial device of the optics arrangement to be connected accurately in position to the first partial device.

In at least some embodiments, in addition to the positioning arrangement, a magnet arrangement is used, which ensures the required retaining forces to connect the second partial device reliably to the first partial device during the measurement.

By way of the selection and arrangement of the magnets of the magnet arrangement, the retaining forces can be exactly dimensioned so that the second partial device is fixedly connected to the first partial device, and the second partial device can be separated without problems from the first partial device by applying a defined separating force.

In at least some embodiments, a spring arrangement, a system which generates a partial vacuum, an arrangement having a bayonet fitting, or a bolt, for example, a bolt to be actuated electromechanically, can be used instead of the magnet arrangement to apply the required retaining forces.

In at least some embodiments, the second partial device only comprises a few optical components (for example, only one optical lens), to keep the costs of the second partial device within acceptable limits.

The measuring device may be equipped in at least some embodiments with at least one (NC-)controlled axis, wherein this can be, for example, a linear axis for moving the optical, contactlessly operating measuring arrangement in relation to the (e.g., gearwheel) component and/or an axis of rotation for rotationally driving the (e.g., gearwheel) component in relation to the measuring arrangement. Such a measuring device having at least one (NC-)controlled axis enables the high-accuracy positioning of the optics arrangement in relation to the object plane.

At least some embodiments use at least one optical measuring arrangement, which enables a high-accuracy and rapid distance determination in that a suitable replaceable optical unit is temporarily fixed on the measuring arrangement for the respective usage case.

The nominal distance of the measuring arrangement can be, for example, in the range of 5 to 50 mm in at least some embodiments. To be able to cover this distance range of the nominal distance, the measuring range can comprise two or more than two different replaceable optical units in at least some embodiments.

The measurement range of the measuring arrangement can be, for example, in the range of ±0.3 mm in at least some embodiments if the suitable replaceable optical unit is temporarily installed in each case.

In at least some embodiments, one linear axis/multiple linear axes enables/enable a high-accuracy positioning of the optics arrangement in relation to the object plane (wherein one or more of the axes of the measuring device can be NC-controlled).

At least some embodiments are based on an overall constellation (configuration) of the measuring device, in which the (e.g., gearwheel) component is accommodated having its axis of rotation concentric to an axis of rotation of a rotationally-drivable receptacle of the device. The axis of rotation of the rotationally-drivable receptacle is vertical in space in this case. The measuring arrangement is configured in at least some embodiments so that it emits a light beam, which extends radially in relation to the axis of rotation of the rotationally-drivable receptacle or which extends tangentially in relation to a circle located concentrically in relation to the axis of rotation. In this case, this light beam propagates in a plane which is substantially perpendicular to the axis of rotation of the rotationally-drivable receptacle.

In at least some embodiments, the plane of the light beam can be set slightly inclined, which can be used, for example, for measuring bevel gears.

At least some embodiments may be used in conjunction with 1D, 2D, and 3D surface measurements on (e.g., gearwheel) components, for example, gearwheels, planar clutch elements, and the like.

This is a device which is suitable for high-accuracy distance measurement. The confocal measurement approach measures point by point. The projected light spot is reflected from the surface. Only the wavelength of the light in focus is detected from this reflection. The distance can be determined from the wavelength, i.e., it is solely a point-distance measurement. A computer reconstruction of the surface can be generated from the combination of a plurality of distances thus measured and the coordinates associated therewith, which are formed from the axial positions.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations, and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Exemplary embodiments, which are understood not to be limiting, are described in greater detail hereafter with reference to the drawings.

FIG. 1A shows a schematic illustration of a light measurement device a light beam onto a gearwheel tooth, wherein only a single tooth of a gearwheel component and the beam path of a confocal-chromatic optical system are shown;

FIG. 1B shows a schematic graph of light intensity over wavelength;

FIG. 2 schematically shows an embodiment of a light measuring device;

FIG. 3 schematically shows a further embodiment of a light measuring device;

FIG. 4 schematically shows a further embodiment of an optics arrangement;

FIG. 5A shows a schematic view of the end face of a first part of a further embodiment of an optics arrangement;

FIG. 5B shows a schematic view of the end face of a first part of a further embodiment of an the optics arrangement;

FIG. 6 shows a schematic view of a further embodiment of an optics arrangement.

### DETAILED DESCRIPTION

Terms are used in conjunction with the present description which are also used in relevant publications and patents. However, it is to be noted that the use of these terms is merely to serve for better comprehension. The inventive concepts and the scope of protection of the claims are not to be restricted in the interpretation by the specific selection of the terms. The invention may be readily transferred to other term systems and/or technical fields. The terms are to be applied accordingly in other technical fields.

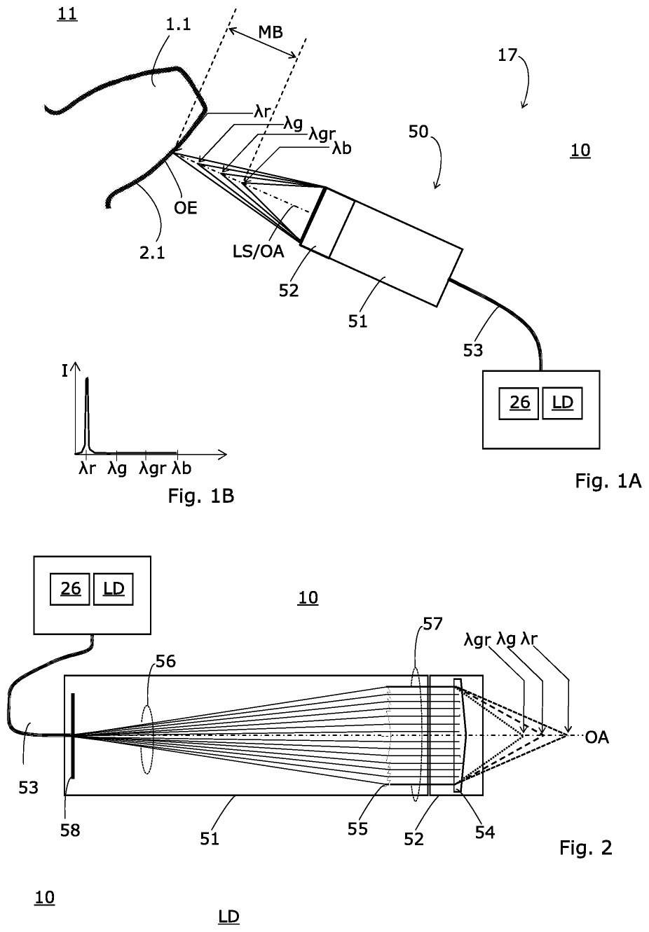

Aspects will be described hereafter on the basis of the schematic illustration of FIG. 1A. Only a single tooth 1.1 of a gearwheel component 11 is shown in FIG. 1A. Moreover, the beam path of a confocal-chromatic optical system is schematically shown in FIG. 1A.

An optics device 50 is used, which comprises a first partial device 51 and a second partial device 52. The first partial device 51 is fixedly connected via an optical waveguide 53 to the light source LD and the detector 26 in the exemplary embodiment shown. The second partial device 52 is removably arranged on the first partial device 51.

It can be seen in FIG. 1A that the measuring arrangement 17 (which comprises here the light source LD, the detector 26, the optical waveguide 53, the first partial device 51, and the second partial device 52) is designed so that it is capable of emitting a light beam LS along an optical axis in the direction of an object plane OE of the gearwheel component 11. The light of the light beam LS is generated by the light source LD and coupled by the optical waveguide 53 into the first partial device 51. From there, the light beam LS extends through the second partial device 52 to generate a strongly focused light spot on the object plane OE.

Either a white light source LD is used, which generates all spectral components of white light, or a light source LD is used which generates light having multiple wavelength components as the light beam LS. A light source LD which generates light having multiple wavelength components is also referred to here as a broad-spectrum light source.

Because of the fact that the light beam LS comprises multiple different wavelength components (colored light components) and because of the fact that the optics arrangement 50 is designed so that the different wavelength components each have a different focal length, the distance between the optics arrangement 50 and the object plane OE can be measured as follows.

FIG. 1A shows by way of example that the wavelength λr of the red light component has a different focal length than the wavelengths λ of the yellow light component, λgr of the green light component, and λb of the blue light component. In the example shown, the object plane OE is located exactly in the focus of the red light component. Therefore, primarily the red light component is reflected back and conducted through the optics arrangement 50 to the detector 26. The detector 26 primarily receives and detects the red wavelength component in this example.

In FIG. 1B, the light intensity I is plotted over the wavelength on the basis of a schematic graphic. The intensity has a maximum at the red wavelength λr.

Since the focal length of the optics arrangement 50, which comprises a first partial device 51 here, for example, is known, the relative distance to the object plane OE can be computed from the location of the intensity maximum and the focal length.

In general, it can be stated that the optics arrangement 50 is designed so that the different spectral components of the light beam LS are focused at different distances from the optics arrangement 50. A measurement range MB thus results, which is indicated in FIG. 1A.

Two or more than two different second partial devices 52 are used, wherein each of these devices 52 has a different measurement range MB. The different measurement ranges MB of the different second partial devices 52 result, for example, in that these partial devices 52 comprise lenses 54 which have different focus properties.

If the position of the optics arrangement 50 in three-dimensional space is known in the device 11, the absolute position of the object plane OE in three-dimensional space can thus be ascertained from the relative distance in relation to the object plane OE.

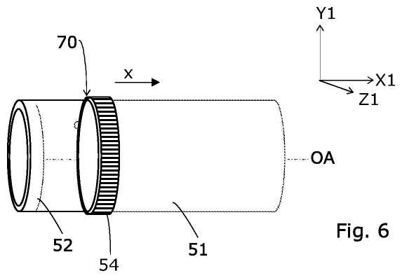

In at least some embodiments which comprise a measuring device 10 having NC-controlled axes (this measuring device 10 is identified here as a coordinate measuring device 10), the position of the individual axes is known. The position of the optics arrangement 50 in three-dimensional space can be computed from the instantaneous position of the individual axes. A possible assignment of the NC-controlled linear axes X1, Y1, Z1 is shown in FIGS. 4 and 6.

Details of a further embodiment are shown in FIG. 2. The internal structure of the optics arrangement 50 can be seen in this figure. The optics arrangement 50 comprises a first part 51 and a second part 52. The second part 52 comprises an optical lens 54 here, which is designed to split the white light into spectral components having different focal lengths.

In at least some embodiments, a converging lens having chromatic aberration is used as the lens 54. The external form of this lens 54 is shown solely schematically in the figures. The lens 54 is a planar-convex lens having positive focal length, which is not dispersion-corrected. I.e., the lens 54 displays a refraction behavior which is dependent on the wavelength. The lens 54 refracts short-wave light (blue) more strongly than long-wave light (red) and the white light is thus decomposed into its spectral colors. I.e., the lens 54 has different focal lengths for the various wavelengths.

The beam paths of three different wavelengths are shown by different dashed lines in FIG. 2. Red light (see λr) has a focus which is spaced apart farthest from the lens 54. The focus of yellow light (see λg) and the focus of green light (see λgr) follow. The light beam LS has no or only a minor blue component here.

The optics arrangement 50 furthermore comprises a lens 55, which is arranged here in the first part 51, which generates a parallel beam path 57 from the beam bundle 56. In at least some embodiments, a Fresnel lens is used as the lens 55. Instead of a Fresnel lens, a converging lens can also be dimensioned/designed so that it bundles the diverging beams of the beam bundle 56 to form a beam bundle 57 having parallel beams as the lens 55.

In at least some embodiments, the optics arrangement 50 can comprise a pinhole screen 58, to refract the light which is guided from the optical waveguide 53 into the interior of the first part 51 into a beam bundle 56.

Light which is reflected on the object plane OE is guided through the lens 54 and the lens 55 back in the direction of the pinhole screen 58. At the pinhole screen 58, this light is coupled into the optical waveguide 53 and conducted therein to the detector 26. The illumination beam path and the imaging beam path extend along the same optical path if it is a confocal chromatic optics arrangement 50.

In at least some embodiments, the detector 26 is designed as a spectrometer to be able to ascertain the dominant light component (spectral component) of the imaging beam path.

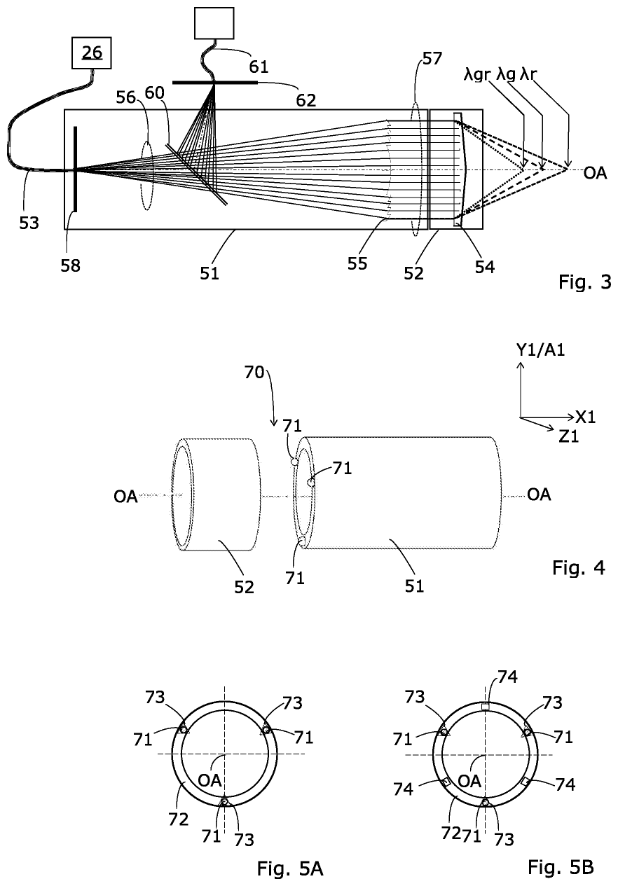

In at least some embodiments, the optics arrangement 50 is designed so that the illumination beam path and the imaging beam path extend at least partially along a different optical path. A corresponding example can be inferred from FIG. 3. Reference is made to the description of FIG. 2 in conjunction with FIG. 3. Only the essential differences will be described hereafter.

The embodiment of FIG. 3 comprises a semitransparent mirror 60, which is arranged in the beam path so that the imaging beam path is guided through the mirror 60 in the direction of the pinhole screen 58 and the detector 26. The light of the light source LD is guided via an optical waveguide 61 to a further pinhole screen 62. At this pinhole screen 62, the light is fanned out by refraction and coupled in a confocal manner into the beam bundle 56 via the mirror 60.

In at least some embodiments, the illumination beam path can also be projected onto the object plane OE completely past the optics arrangement 50.

In at least some embodiments, the following steps are used if an optical distance measurement is to be performed on an object plane OE of a gearwheel component 11. The sequence of the steps does not necessarily have to correspond to the sequence given hereafter.

The method according to at least some embodiments comprises the following steps:

Selecting one partial device 52 (identified here as the second partial device 52) from a set of partial devices, which differ due to different optical measurement ranges MB. The partial devices can be provided, for example, in a magazine in the vicinity of the measuring device 10. The selection of the partial device 52 can take place manually or automatically.

Providing an optics arrangement 50 by attaching the selected second partial device 52 to a first partial device 51 in such a way that an optical axis OA of the optics arrangement 50 results, which extends concentrically through both partial devices 51, 52 in the direction of the object plane OE. The attachment of the second partial device 52 to the first partial device 51 can take place manually or automatically (for example, using a robot arm).

Positioning the optics arrangement 50 in relation to the object plane OE, wherein a relative distance between the optics arrangement 50 and the object plane OE is specified which is in the range of the optical measurement ranges MB of the selected partial device 52. The positioning may be performed by moving one or more axes of the measuring device 10. A mean distance in relation to the object plane OE may be specified, which is located approximately in the middle within the optical measurement range MB. Approximately the same paths for setting the focal point by way of the relative movement of the optics arrangement 50 thus result in both movement directions (for example, observed perpendicularly to the object plane) in the positive and negative directions.

Coupling in white light or broad-spectrum light having multiple spectral components in such a way that the white light or the broad-spectrum light forms different focal points for the spectral components in the optical measurement range MB (as shown by way of example in FIGS. 1A, 2, and 3).

Coupling a spectral component (also referred to here as an observation beam path), the focal point of which has encountered/intersected the object plane OE, into the optics arrangement 50.

Guiding this spectral component to a detector 26, which is designed for spectral analysis of this spectral component.

Ascertaining the wavelength of this spectral component or detecting this spectral component.

Ascertaining distance information from the ascertained wavelength and from information which defines the optical measurement range MB of the selected partial device 52.

In at least some embodiments, the optics arrangement 50 comprises a positioning arrangement 70, which enables it to connect the second partial device 52 accurately in position to the first partial device 51. In at least some embodiments, the positioning arrangement 70 may comprise three rotationally-symmetrical bodies 71 (for example, three balls or cylinder elements) and three corresponding receptacle regions. The corresponding receptacle regions cannot be seen in FIG. 4, since they are provided on the nonvisible end face of the second partial device 52. An accurately defined three-point mounting thus results (to be precise, it is a six-point mounting) of the second partial device 52 on the first partial device 51.

The first partial device 51 and the second partial device 52 each have, for example, the basic shape of a hollow cylinder. The optical elements (e.g., lenses 54, 55, pinhole screen(s) 58, semitransparent mirrors 60, prisms, gratings, etc.) can be arranged in the interior of the hollow cylinder, as indicated by way of example in FIGS. 2 and 3.

FIG. 5A shows the view of the end face of an exemplary first partial device 51 in very schematic form. The first partial device 51 also has a hollow-cylindrical shape in at least this embodiment. In the region of the end face, a ring-shaped surface 72 results, which is perpendicular to the optical axis OA, because of the wall thickness of the hollow cylinder. The ring-shaped surface 72 can also result because a collar or a shoulder is provided on the hollow cylinder.

As shown in FIG. 5A, three balls 71 (shown gray) are used here as rotationally-symmetrical bodies. These rotationally-symmetrical bodies 71 have a mutual angle distance of 120° here. The second partial device 52 has a corresponding ring-shaped surface on the end face, which faces toward the first partial device 51. In the region of this corresponding ring-shaped surface, three prismatic recesses are provided, which also have a mutual angle distance of 120°. The prismatic recesses are designed in the dimensioning and arrangement so that they correspond to the rotationally-symmetrical bodies 71. In FIG. 5A, the outlines of the three prismatic recesses 73 are indicated by dashed triangles.

Upon joining together of the second partial device 52 with the first partial device 51, self-centering of the cylinder axes of the two hollow cylinders occurs due to the use of the positioning arrangement 70. It is ensured by the self-centering that the optical axis is located concentrically in relation to the two cylinder axes.

FIG. 5B shows the view of the end face of a further exemplary first partial device 51 in very schematic form. Reference is made here to the description of FIG. 5A. In contrast to the embodiment of FIG. 5A, the embodiment of FIG. 5B comprises a magnet arrangement having three (permanent) magnets 74. Retaining forces result, which can be dimensioned by the magnet strength and positioning of the magnets 74 exactly in such a way that the second partial device 52 is fixedly connected to the first partial device 51, and the second partial device 52 can be separated without problems from the first partial device 51 by applying a defined separating force. In the exemplary embodiment shown in FIG. 5B, three (permanent) magnets 74 are used, which have an angle distance of 60° in relation to the rotationally-symmetrical bodies 71. The three (permanent) magnets 74 each have an angle distance of 120° from one another.

Since a (coordinate) measuring device 10 is a sensitive device, the embodiments which operate using (permanent) magnets 74 can comprise means which enable a careful separation of the second partial device 52 from the first partial device 51. A procedure in which only minor traction and/or shear forces are exerted via the first partial device 51 on the (coordinate) measuring device 10 is considered to be a careful separation here.

For this purpose, the first partial device 51 and/or the second partial device 52 can be provided, for example, with a lever or handle element, which acts on the respective other partial device so that a small air gap is created between the (permanent) magnets 74 and a metallic counterpart. The retaining forces are significantly reduced by the creation of a small air gap and the second partial device 52 can be separated from the first partial device 51 nearly without force.

As shown in FIG. 6 in schematic form, a ring element 62 can also be provided on the first partial device 51 for the mentioned purpose. This ring element 62 can be, for example, spring-loaded so that the distance between the (permanent) magnets 74 and a metallic counterpart is enlarged by pulling the ring element 62 in the x direction. The retaining forces are significantly reduced by the pulling and the second partial device 52 can be separated from the first partial device 51 nearly without force. The ring element 62 can accordingly also be designed so that the retaining forces are reduced by a rotation of the ring element 62 around the cylinder axis of the hollow cylinder, which is a component of the first partial device 51.

In at least some embodiments, a spring arrangement, a system which generates a partial vacuum, an arrangement having a bayonet fitting, or a bolt, for example, a bolt to be actuated electromechanically, can be used instead of the magnet arrangement as a part of the (coordinate) measuring device 10 for applying the required retaining forces.

At least some embodiments are based on an overall constellation (configuration) of the measuring device 10, in which the (e.g., gearwheel) component 11 is accommodated having its axis of rotation concentric to an axis of rotation A1 of a rotationally-drivable receptacle of the device. The axis of rotation A1 of the rotationally-drivable receptacle is vertical in space in this case (parallel to the Y1 axis, which is shown in FIG. 4). The measuring arrangement 50 is designed in at least some such embodiments so that it emits a light beam LS, which extends radially in relation to the axis of rotation A1 of the rotationally-drivable receptacle, or tangentially in relation to a circle which is concentric in relation to the axis of rotation A1. In this case, this light beam LS propagates in a plane which is essentially perpendicular to the axis of rotation A1 of the rotationally-drivable receptacle. In the example of FIG. 4, this plane is parallel to the plane spanned by the X1 axis and Z1 axis.

In at least some embodiments, the plane of the light beam LS can be set slightly inclined, which can be used, for example, for measuring bevel gears.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A device comprising:
at least one controlled axis,
a receptacle configured to receive a component and defining an axis of rotation about which a component received by the receptacle is rotationally-drivable, and
an optical, contactlessly operating measuring device having a light source, optics, and an optical detector;
wherein the measuring device is configured to
emit a light beam from the light source along an optical axis in a direction of an object plane of a component received in the receptacle, and
guide components of the light beam having different wavelengths reflected from the object plane through the optics in a direction of the optical detector;
wherein the optics comprises a first partial device fixedly connected to the optical detector via an optical waveguide, and a second partial device removably connected or connectable to the first partial device.

2. The device according to claim 1, wherein the light source defines a white light source configured to emit the light beam as white light, or wherein the light source defines a broad-spectrum light source configured to emit the light beam containing multiple wavelength components.

3. The device according to claim 2, wherein the measuring device defines a confocal-chromatic optical system.

4. The device according to claim 1, wherein the measuring device is configured to (a) guide the light beam along an illumination beam path in the direction of said object plane, and (b) guide the components of the light beam reflected from the object plane along an observation beam path in the direction of the optical detector.

5. The device according to claim 4, wherein the measuring device is configured such that one or more of the illumination beam path or the observation beam path extends through the optics.

6. The device according to claim 1, wherein the optical detector is configured to perform spectral analysis of said components of the light beam having different wavelengths reflected from the object plane.

7. The device according to claim 1, further comprising a positioning system configured to removably connect the second partial device to the first partial device, wherein the positioning system comprises three rotationally-symmetrical bodies and three corresponding receptacle regions.

8. The device according to claim 1, further comprising
a magnet system,
a spring system,
a system configured to generate a partial vacuum,
a bayonet fitting, or
a bolt
configured to removably connect the second partial device to the first partial device.

9. The device according to claim 8, wherein the bolt defines an electromechanically-actuated bolt.

10. The device according to claim 1, further comprising at least one further second partial device removably connectable to the first partial device and defining one or more of an optical measurement range or a measurement distance different from an optical measurement range or measurement distance of the second partial device.

11. The device according to claim 1, wherein said component defines a gearwheel component.

12. The device according to claim 2, wherein the optical detector is configured to perform spectral analysis of said components of the light beam having different wavelengths reflected from the object plane.

13. The device according to claim 3, wherein the optical detector is configured to perform spectral analysis of said components of the light beam having different wavelengths reflected from the object plane.

14. The device according to claim 4, wherein the optical detector is configured to perform spectral analysis of said components of the light beam having different wavelengths reflected from the object plane.

15. The device according to claim 2, further comprising at least one further second partial device removably connectable to the first partial device and defining one or more of an optical measurement range or a measurement distance different from an optical measurement range or measurement distance of the second partial device.

16. The device according to claim 4, further comprising at least one further second partial device removably connectable to the first partial device and defining one or more of an optical measurement range or a measurement distance different from an optical measurement range or measurement distance of the second partial device.

17. The device according to claim 6, further comprising at least one further second partial device removably connectable to the first partial device and defining one or more of an optical measurement range or a measurement distance different from an optical measurement range or measurement distance of the second partial device.

18. The device according to claim 7, further comprising at least one further second partial device removably connectable to the first partial device and defining one or more of an optical measurement range or a measurement distance different from an optical measurement range or measurement distance of the second partial device.

19. A method comprising:
optically measuring a distance to an object plane of a component, including the following steps:
selecting a first partial device from a set of first partial devices, wherein each first partial device of the set defines one or more of an optical measurement range or a measurement distance different from each other first partial device of said set,
attaching the selected first partial device to a second partial device, thereby forming an optics system defining an optical axis extending concentrically through both the selected first partial device and the second partial device in a direction of the object plane,
positioning the optics system at a distance from the object plane within the optical measurement range of the selected first partial device,
coupling into the optics system white light or broad-spectrum light having multiple spectral components so that the white light or broad-spectrum light forms different focal points for the spectral components within the optical measurement range of the selected first partial device,
coupling into the optics system a spectral component of the spectral components, the focal point of which intersected the object plane,
guiding said spectral component to a detector configured to perform spectral analysis of said spectral component,
determining a wavelength of said spectral component or detecting said spectral component,
determining distance information relating to said distance using the wavelength and information defining the optical measurement range of the selected first partial device.

20. The method according to claim 19, wherein said component defines a gear wheel component.
